(19) United States
(12) Patent Application Publication
(10) Pub. No.: US 2025/0373023 A1
(43) Pub. Date: Dec. 4, 2025

(54) HYDROGEN FUELED ELECTRICAL SYSTEM

(71) Applicant: Salas O’Brien, Inc., Irvine, CA (US)

(72) Inventor: Duc P. Bui, Orange, CA (US)

(21) Appl. No.: 19/227,153

(22) Filed: Jun. 3, 2025

Related U.S. Application Data
(60) Provisional application No. 63/655,906, filed on Jun. 4, 2024.

(51) Int. Cl. H02J 3/38; H02J 3/00; H02J 3/28; H02J 15/00

(52) U.S. Cl. CPC H02J 3/381; H02J 3/001; H02J 3/28; H02J 15/008; H02J 2300/20; H02J 2300/30; H02J 2310/12

(57) ABSTRACT

An electrical system may power a facility, such as a hospital. The system may include a hydrogen production facility and a storage system located on-site at the facility. A plurality of generators may use hydrogen produced at the hydrogen production facility to generate power for the facility. A battery energy storage system may be configured to store excess power produced by a renewable energy source and/or the plurality of generators. A microgrid controller may be configured to direct power from the utility power source to the facility during a non-emergency event and to direct produced by the plurality of generators instead of the power from the utility power source to the facility during an emergency event. The microgrid may be configured to direct power from one of the utility power source, the renewable energy power source, or the battery energy storage system to the hydrogen production facility.

### INCORPORATION BY REFERENCE TO ANY PRIORITY APPLICATIONS

This application claims priority to U.S. Provisional Patent Application No. 63/655,906, filed Jun. 4, 2024, entitled “HYDROGEN FUELED ELECTRICAL SYSTEM,” the entirety of which is incorporated herein by reference. Any and all applications for which a foreign or domestic priority claim is identified in the Application Data Sheet as filed with the present application are hereby incorporated by reference under 37 CFR 1.57.

### BACKGROUND

### Field

The disclosure relates to electrical systems, such as, in certain embodiments, electrical systems for generating power for facilities, such as hospitals, food production plants, farms, airports, data centers, or the like.

### Description

Typically, facilities, such as hospitals, food production plants, farms, airports, data centers, etc., are required to the install an emergency generator. The emergency generator may power the facility during an emergency event, such as a power outage caused by public safety power shutoff, weather, a natural disaster, or the like. In some jurisdictions, due to stricter regulations on air pollution, the installation of emergency diesel generators has become a significant undertaking. Installing a generator in accordance with EPA and local air quality control regulations can add an additional cost of about $500,000 to $600,000 per generator, and facilities are typically only permitted to run the generators during an emergency event. Furthermore, facilities are subject to a fine if the generator runs for longer than the limits set forth in EPA and local air quality control regulations.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

In accordance with one aspect of the disclosure, an electrical system for powering a facility includes a hydrogen production facility, hydrogen storage, and/or generators, such as linear generators or fuel cells, in order to allow the facility to generate hydrogen on-site as fuel for the generators.

In some aspects, an electrical system may increase reliability and/or resilience of operations of a facility, so the facility can operate during an emergency event. In some aspects, an electrical system can provide power to the facility in a cost effective manner in order to reduce or minimize energy costs for the facility during operation.

In some aspects, an electrical system for powering a facility may include: a hydrogen production facility connected to a water source, the hydrogen production facility located on-site at the facility, the hydrogen production facility configured to generate hydrogen; a storage system located on-site at the facility, the storage system including a fuel storage and an emergency storage, the fuel storage and the emergency storage configured to hold hydrogen generated by the hydrogen production facility; a plurality of generators, each of the plurality of generators is configured to produce power using fuel, the fuel includes hydrogen from the fuel storage and natural gas from a natural gas source; a renewable energy power source configured to produce power; a battery energy storage system configured to store power produced by the renewable energy source and/or the plurality of generators; and a microgrid controller connected to a utility power source and the plurality of generators, the microgrid controller is configured to direct power from the utility power source to the facility during a non-emergency event and to direct power produced by the plurality of generators instead of the power from the utility power source to the facility during an emergency event, and the microgrid controller is configured to direct power from one of the utility power source, the renewable energy power source, or the battery energy storage system to the hydrogen production facility.

In some aspects, the facility may be a hospital.

In some aspects, each of the plurality of generators may include a linear generator or a fuel cell.

In some aspects, the hydrogen production facility may be configured to generate hydrogen via electrolysis.

In some aspects, the hydrogen production facility may be configured to generate hydrogen, water, oxygen, and heat, and the hydrogen production facility is configured to transport the water, the oxygen, and the heat to the facility.

In some aspects, the hydrogen production facility may be configured to refine the oxygen.

In some aspects, the emergency storage may be configured to provide hydrogen to the plurality of generators to power the plurality of generators during an emergency event.

In some aspects, the emergency storage may be configured to store an amount of hydrogen to power the plurality of generators for 96 hours.

In some aspects, the renewable energy power source may include a solar power source, a wind power source, and/or a hydropower source.

In some aspects, the electrical system further may include a backup hydrogen source connected to the storage system.

In some aspects, an electrical system for powering a facility, the electrical system may include: a hydrogen production facility connected to a water source, the hydrogen production facility located on-site at the facility, the hydrogen production facility configured to generate hydrogen; a storage system located on-site at the facility configured to hold hydrogen generated by the hydrogen production facility; a generator configured to produce power using fuel, the fuel includes hydrogen from the storage system; and a microgrid controller connected to a utility power source and the generator, the microgrid controller is configured to direct power from the utility power source to the facility during a non-emergency event and to direct power produced by the generator instead of the power from the utility power source to the facility during an emergency event.

In some aspects, the facility may be a hospital.

In some aspects, the generator may include a linear generator or a fuel cell.

In some aspects, the storage system may include a fuel storage and an emergency storage.

In some aspects, the fuel may include hydrogen from the fuel storage.

In some aspects, the emergency storage may be configured to provide hydrogen to the generator to power the generator during an emergency event.

In some aspects, a method of powering a facility with an electrical system during an emergency event, where power is provided to the facility from a utility power source during a non-emergency event, the method may include: disconnecting, by a microgrid controller of the electrical system, the utility power source from the electrical system, directing, by a microgrid controller, power produced by a plurality of generators of the electrical system to the facility to power the facility, the plurality of generators are configured to produce power using fuel, the fuel includes hydrogen produced by a hydrogen production facility located on-site at the facility.

In some aspects, the electrical system may include a storage system located on-site at the facility, the storage system including a fuel storage and an emergency storage, the fuel storage and the emergency storage configured to hold hydrogen generated by the hydrogen production facility, and the method may further include providing hydrogen from the storage system to the plurality of generators.

In some aspects, the electrical system may include a renewable energy source configured to produce power, and a battery energy storage system configured to store power produced by the renewable energy source and/or the plurality of generators.

In some aspects, the facility may be a hospital.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1 illustrates an electrical system for powering a facility, such as a hospital, the electrical system including generators that use hydrogen and/or natural gas as fuel.

FIG. 2 illustrates the electrical system of FIG. 1 with a utility power source disconnected from the electrical system.

FIG. 3 illustrates the electrical system of FIG. 1 with a natural gas source and the utility power source disconnected from the electrical system.

FIG. 4 illustrates an electrical system for powering a facility, such as a hospital, the electrical system including generators that use only hydrogen as fuel.

FIG. 5 illustrates a method of powering a facility with an electrical system during an emergency event.

### DETAILED DESCRIPTION

Although several embodiments, examples, and illustrations are disclosed below, it will be understood by those of ordinary skill in the art that the system, methods, and devices described herein extend beyond the specifically disclosed embodiments, examples, and illustrations and includes other uses of the system, methods, and devices and obvious modifications and equivalents thereof. Embodiments of the disclosure are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the disclosure. In addition, embodiments of the disclosure can include several novel features and no single feature is solely responsible for its desirable attributes or is essential to practicing the system, methods, and devices herein described.

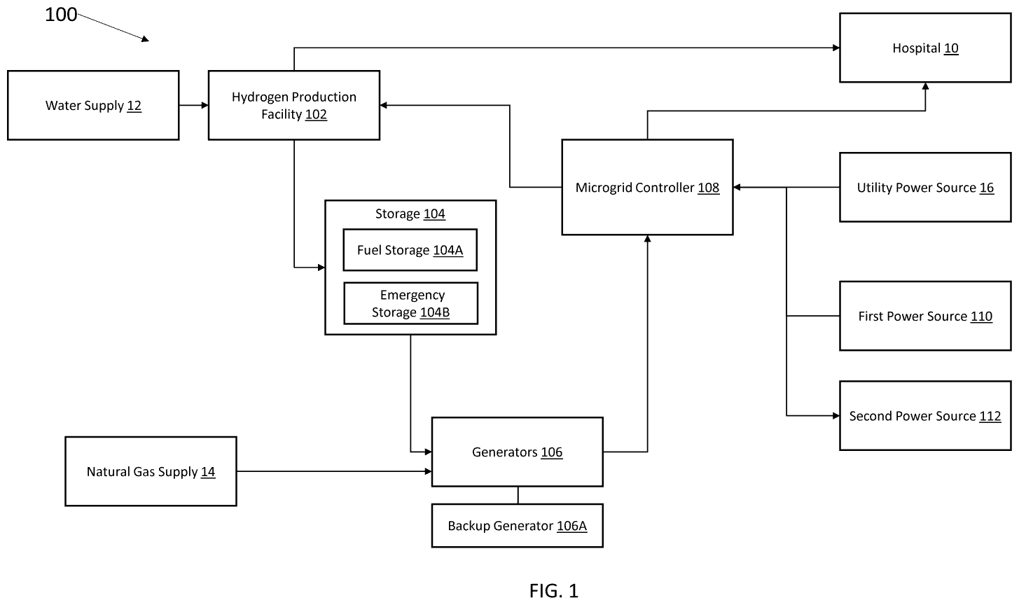

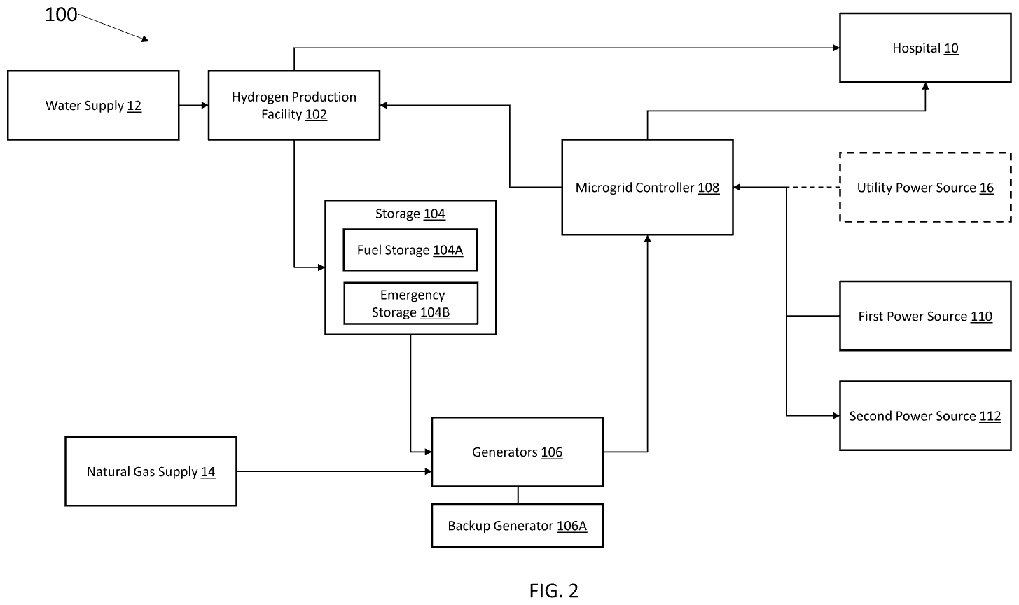

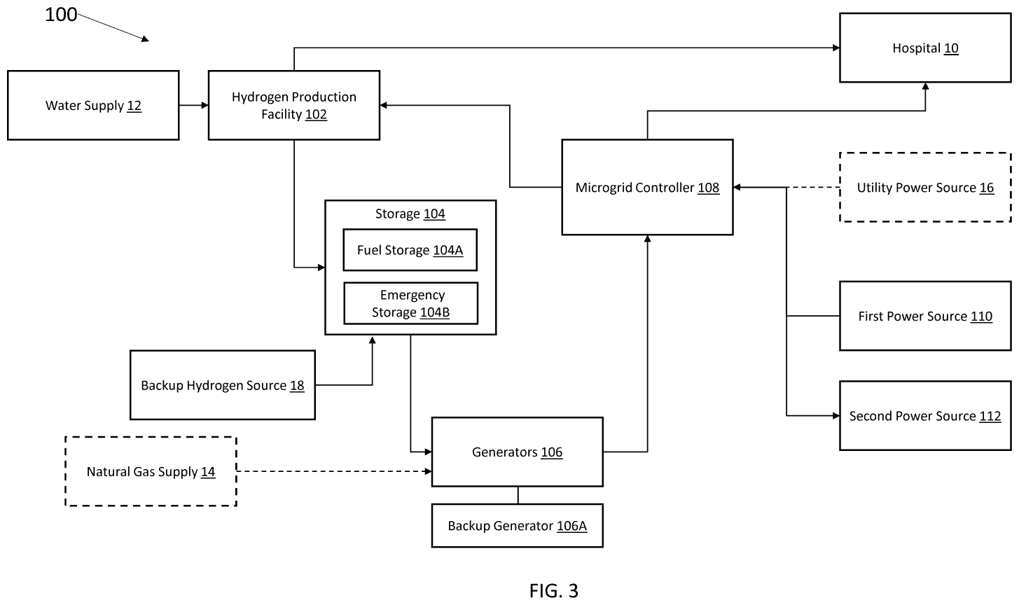

FIG. 1 illustrates an electrical system 100. The electrical system 100 may provide power to a hospital 10. The electrical system 100 may provide power to the hospital 10 during a non-emergency event (e.g., normal operation), as shown in FIG. 1 and/or an emergency event, as shown in FIGS. 2 and 3. The electrical system 100 may operate in a co-generation mode during a non-emergency event, and/or an emergency power mode during an emergency event. The hospital 10 may include a general hospital, a psychiatric hospital, a rehabilitation facility, a surgical center, an urgent care facility, and/or any other hospital or healthcare facility. The electrical system 100 may include a hydrogen production facility 102, a storage system 104, one or more generators 106, a microgrid controller 108, a first power source 110, and/or a second power source 112. It is to be appreciated that although the electrical system 100 is shown and described as providing power to a hospital 10, the electrical system 100 may be used to provide power to other facilities, such as food production plants, farms, airports, data centers, schools, houses, multi-family housing complexes, assisted-living facilities, police stations, and/or any other facilities.

In some embodiments, the hydrogen production facility 102 may generate (e.g., produce) hydrogen. The hydrogen production facility 102 may be positioned (e.g., located) onsite at the hospital 10. In some embodiments, the hydrogen production facility 102 may be positioned offsite. The hydrogen production facility 102 may include an electrolyzer. Accordingly, the hydrogen production facility 102 (e.g., the electrolyzer) may generate hydrogen via electrolysis. The hydrogen production facility 102 may use water as an input. Accordingly, the hydrogen production facility 102 may be connected to a water supply 12. The hydrogen production facility 102 may use electrolysis to split the water into its constituent gases: hydrogen and oxygen. The hydrogen production facility 102 may output heat, water, and/or oxygen as a byproduct of generating hydrogen via electrolysis. In some embodiments, the hydrogen production facility 102 may be configured to generate hydrogen using any other hydrogen production methods.

In some embodiments, the heat output by the hydrogen production facility 102 may be transported to the hospital 10. The heat output by the hydrogen production facility 102 may be transported to a heat exchanger in the hospital 10. The heat output by the hydrogen production facility 102 may be used to heat the hospital 10 and/or to heat water for the hospital 10. In some embodiments, the water output by the hydrogen production facility 102 may be transported to the hospital 10. The water output by the hydrogen production facility 102 may be transported to a central processing facility of the hospital 10. The water output by the hydrogen production facility 102 may include deionized water. Accordingly, the deionized water may be used by the hospital 10 for sterilization of medical equipment, hand washing, laundry, cleaning, and/or any other purpose. In some embodiments, the oxygen output by the hydrogen production facility 102 may be released into the atmosphere. In some embodiments, the oxygen output by the hydrogen production facility 102 may be transported to the hospital 10. The oxygen output by the hydrogen production facility 102 may be refined by the hospital 10. The oxygen output by the hydrogen production facility 102 may be refined from standard grade oxygen to medical grade oxygen. In some embodiments, the hydrogen production facility 102 may be configured to refine the oxygen. In some embodiments, the oxygen may be transported to one or more oxygen tanks located, installed, or otherwise present in the hospital 10. Transporting the oxygen output by the hydrogen production facility 102 to the hospital 10 may reduce or eliminate the need for the hospital 10 to have oxygen delivered from off site to refill the one or more oxygen tanks.

In some embodiments, the hydrogen generated by the hydrogen production facility 102 may be transported to the storage system 104. The storage system 104 may be positioned onsite at the hospital 10. In some embodiments, the storage system 104 may be positioned offsite. The storage system 104 may include a fuel storage 104A and/or an emergency storage 104B. The storage system 104 may be connected to the generators 106. The storage system 104 may be configured to provide hydrogen to the generators 106 in order to power the generators 106. The storage system 104 may provide hydrogen to the generators 106 from the fuel storage 104A. During an emergency event, such as a power outage caused by public safety power shutoff, weather, a natural disaster, or the like, the storage system 104 may provide hydrogen from the emergency storage 104B. In some embodiments, the emergency storage 104B may be configured to store at least an amount of hydrogen to power the generators 106 for at least a minimum amount of time. The minimum amount of time may be an amount of time required by local law. For example, local law may require the emergency storage 104B be configured to store sufficient hydrogen to power the generators 106 for 96 hours. In some embodiments, the minimum amount of time may include 1 hour, 2 hours, 3 hours, 4 hours, 5 hours, 6 hours, 10 hours, 12 hours, 15 hours, 18 hours, 20 hours, 24 hours, 25 hours, 30 hours, 35 hours, 36 hours, 40 hours, 42 hours, 45 hours, 48 hours, 50 hours, 54 hours, 55 hours, 60 hours, 65 hours, 66 hours, 70 hours, 72 hours, 75 hours, 78 hours, 80 hours, 84 hours, 85 hours, 90 hours, 95 hours, 96 hours, 100 hours, 120 hours, 144 hours, 168 hours, 200 hours, and/or any value between the aforementioned values.

In some embodiments, the electrical system 100 may include one (1) generator 106, two (2) generators 106, three (3) generators 106, four (4) generators 106, five (5) generators 106, six (6) generators 106, seven (7) generators 106, eight (8) generators 106, nine (9) generators 106, ten (10) generators 106, fifteen (15) generators 106, twenty (20) generators 106, twenty-five (25) generators 106, thirty (30) generators 106, thirty-five (35) generators 106, forty (40) generators 106, forty-five (45) generators 106, fifty (50) generators 106, one-hundred (100) generators 106, one-hundred (150) generators 106, two-hundred (200) generators 106, and/or any value between the aforementioned values.

In some embodiments, the generators 106 may include one or more linear generators and/or any other non-combustible generators and/or fuel cells. In some embodiments, the generators 106 may be fuel-agnostic. As described above, the generators 106 may receive hydrogen from the storage system 104. In some embodiments, the generators 106 may be connected to a natural gas supply 14. The natural gas supply 14 may include a utility company or provider. The generators 106 may use hydrogen from the storage system 104 and/or natural gas from the natural gas supply 14 as fuel. In some embodiments, the generators 106 may use about 60 percent hydrogen and about 40 percent natural gas as fuel. In some embodiments, the microgrid controller 108 may be configured to control the amount of hydrogen from the storage system 104 and/or the amount of natural gas from the natural gas supply 14 provided to the generators 106 as fuel for the generators 106. The generators 106 may generate power (e.g., electricity). The power generated by the generators 106 may be transferred or transported to the microgrid controller 108. In some embodiments, the microgrid controller 108 may transfer or transport (e.g., direct) the power generated by the generators 106 to the hospital 10.

In some embodiments, the generators 106 may be connected in parallel. Accordingly, the power generated by the generators 106 may include a sum of the power generated by each generator 106. The electrical system 100 may include a number of generators 106 necessary to power the hospital 10. The number of generators 106 necessary to power the hospital 10 may be determined based on an amount of power each generator 106 can generate and an amount of power consumed by the hospital 10. For example, each generator 106 may be configured to generate 250 kilowatts (kW) and the hospital 10 may consume 5 megawatts (MW). Accordingly, the electrical system 100 may include 20 generators 106.

In some embodiments, the electrical system 100 may include more generators 106 than necessary to power the hospital 10. The electrical system 100 may include a backup generator 106A. The backup generator 106A may be connected to the generators 106 in parallel. Accordingly, if one of the generators 106 breaks or malfunctions, the backup generator 106A may produce power in order to replace the broken or malfunctioned generators 106. Therefore, the number of generators 106 producing power is still sufficient to power the hospital 10. In some embodiments, the backup generator 106A may include extra generators 106. Accordingly, the backup generator 106A may produce power when the generators 106 produce power. Therefore, the generators 106 and the backup generator 106A may produce more power than necessary to power the hospital 10 when all of the generators 106 and the backup generator 106A produce power. In some embodiments, the backup generator 106A may be configured to automatically produce power when the hospital 10 requires more power than the amount of power produced by the generators 106. In some embodiments, the electrical system 100 may include one (1) backup generator 106A, two (2) backup generators 106A, three (3) backup generators 106A, four (4) backup generators 106A, five (5) backup generators 106A, six (6) generators 106, seven (7) backup generators 106A, eight (8) backup generators 106A, nine (9) backup generators 106A, ten (10) backup generators 106A, twenty (20) backup generators 106A, thirty (30) backup generators 106A, forty (40) backup generators 106A, and/or fifty (50) backup generators 106A. In some embodiments, the electrical system 100 may include between two (2) and five (5) backup generators 106A.

In some embodiments, the first power source 110 and/or the second power source 112 may be configured to generate power. The first power source 110 may include a renewable energy power source. The first power source 110 may include a solar power source, a wind power source, hydropower source, and/or any other renewable energy power source. In some embodiments, the first power source 110 may include one or more solar panels. The second power source 112 may include a battery energy storage system (BESS). The second power source 112 may be configured to store power generated by the first power source 110. In some embodiments, the second power source 112 may be configured to store power generated by the generators 106 and/or power from a utility power source 16. In some embodiments, the first power source 110 and the second power source 112 may both include a renewable energy source.

In some embodiments, the first power source 110 and/or the second power source 112 may be connected to the microgrid controller 108. The power generated by the first power source 110 may be transferred or transported to the microgrid controller 108. The power generated by and/or stored in the second power source 112 may transferred or transported to the microgrid controller 108.

In some embodiments, the microgrid controller 108 may be connected to the utility power source 16. The utility power source 16 may include a utility company or provider. The utility power source 16 may provide power to the microgrid controller 108 from the utility company or provider.

In some embodiments, the microgrid controller 108 may be configured to control where power is transmitted or transferred throughout the electrical system 100. In some embodiments, the microgrid controller 108 may receive power from the generators 106, the first power source 110, the second power source 112, and/or the utility power source 16. The microgrid controller 108 may transmit or transfer power from the generators 106, the first power source 110, the second power source 112, and/or the utility power source 16 to the hospital 10. The microgrid controller 108 may transmit or transfer power from the generators 106, the first power source 110, the second power source 112, and/or the utility power source 16 to the hydrogen production facility 102 in order to power the hydrogen production facility 102. In some embodiments, the microgrid controller 108 may be configured to connect and/or disconnect the generators 106, the first power source 110, the second power source 112, and/or the utility power source 16. In some embodiments, the microgrid controller 108 may be configured to turn on/off the hydrogen production facility 102, the generators 106, the first power source 110, and/or the second power source 112. The microgrid controller 108 may be configured to connect and/or disconnect the generators 106, the first power source 110, the second power source 112, and/or the utility power source 16 in response an emergency event, a loss of power from the utility power source 16, a loss of natural gas from the natural gas supply 14, a change in power required to power the hospital 10, and/or any other event. The microgrid controller 108 may be configured to instantaneously connect and/or disconnect the generators 106, the first power source 110, the second power source 112, and/or the utility power source 16. In some embodiments, the microgrid controller 108 may be configured to connect and/or disconnect the generators 106, the first power source 110, the second power source 112, and/or the utility power source 16 within a predetermined time threshold. The predetermined time threshold may include about 1 second, about 2 seconds, about 3 seconds, about 4 seconds, about 5 seconds, about 6 seconds, about 7 seconds, about 8 seconds, about 9 seconds, about 10 seconds, about 11 seconds, about 12 seconds, about 13 seconds, about 14 seconds, about 15 seconds, about 16 seconds, about 17 seconds, about 18 seconds, about 19 seconds, about 20 seconds, about 21 seconds, about 22 seconds, about 23 seconds, about 24 seconds, about 25 seconds, about 26 seconds, about 27 seconds, about 28 seconds, about 29 seconds, about 30 seconds, and/or any value between the aforementioned values.

In some embodiments, the microgrid controller 108 may be configured to control the amount of the total power provided to the hospital 10 and/or the hydrogen production facility 102 from each of the generators 106, the first power source 110, the second power source 112, and/or the utility power source 16. For example, if the first power source 110 is one or more solar panels, the microgrid controller 108 may transmit power from the first power source 110 to the hospital 10 and/or the hydrogen production facility 102 when it is sunny. However, when it is cloudy or nighttime, the first power source 110 may not produce power, so the microgrid controller 108 may modify the amount of the total power provided to the hospital 10 and/or the hydrogen production facility 102 by one or more of the generators 106, the second power source 112 and/or the utility power source 16 so the total power provided to the hospital 10 and/or the hydrogen production facility 102 is the same or substantially the same as the total power provided to the hospital 10 and/or the hydrogen production facility 102 with the first power source 110 providing power.

In some embodiments, the microgrid controller 108 may determine the amount of the total power provided to the hospital 10 and/or the hydrogen production facility 102 from each of the generators 106, the first power source 110, the second power source 112 and/or the utility power source 16 based on a current cost of power from the utility power source 16 and/or a current cost to generate power from the generators 106, the first power source 110, and/or the second power source 112. In some embodiments, the microgrid 108 may be configured to reduce or minimize the cost of the power provided to the hospital 10 and/or the hydrogen production facility 102.

In some embodiments, the microgrid controller 108 may be configured to direct power from the first power source 110 to the second power source 112 and the second power source 112 can store the power from the first power source 110. Accordingly, power stored by the second power source 112 can be provided to the hospital 10 and/or the hydrogen production facility 102.

FIG. 2 illustrates the electrical system 100 with power from the utility power source 16 disconnected, as indicated by dashed lines. In some embodiments, power from the utility source 16 may be disconnected due to an emergency event, such as a power outage caused by public safety power shutoff, weather, a natural disaster, or the like. Accordingly, the electrical system 100 may not receive power from the utility power source 16. Therefore, power from the utility power source 16 may not be provided to the hospital 10 and/or the hydrogen production facility 102 in order to power the hospital 10 and/or the hydrogen production facility 102.

In some embodiments, in response to the utility power source 16 being disconnected, the microgrid controller 108 may modify an amount of power transferred from the generators 106, the first power source 110, and/or the second power source 112 to the hydrogen production facility 102 in order to replace the power that would otherwise be transferred from the utility power source 16 to the hydrogen production facility 102. Accordingly, sufficient power may be transferred to the hydrogen production facility 102 from the generators 106, the first power source 110, and/or the second power source 112 in order to power the hydrogen production facility 102. In some embodiments, the microgrid controller 108 may modify an amount of power transferred from the generators 106, the first power source 110, and/or the second power source 112 to the hospital 10 in order to replace the power that would otherwise be transferred from the utility power source 16 to the hospital 10. Accordingly, sufficient power may be transferred to the hospital 10 from the generators 106, the first power source 110 and/or the second power source 112 in order to power the hydrogen production facility 102.

FIG. 3 illustrates the electrical system 100 with natural gas from the natural gas supply 14 disconnected and power from the utility power source 16, as indicated by dashed lines. In some embodiments, natural gas from the natural gas supply 14 and/or power from the utility power source 16 may be disconnected due to an emergency event, such as a power outage caused by public safety shutoff, weather, a natural disaster, or the like. Accordingly, the electrical system 100 may not receive natural gas from the natural gas supply 14 and/or power from the utility power source 16.

In some embodiments, as described above with reference to FIG. 2, in response to the utility power source 16 being disconnected, the microgrid 108 may modify an amount of power transferred to the hydrogen production facility 102 and/or the hospital 10. In some embodiments, in response to the natural gas supply 14 being disconnected, the microgrid controller 108 (or the generators 106 themselves) may modify an amount of hydrogen transferred or transported to the generators 106 from the storage system 104. The generators 106 may use only hydrogen as fuel. Therefore, the amount of hydrogen transferred or transported to the generators 106 from the storage system 104 may be increased. In some embodiments, the hydrogen production facility 102 may increase production of hydrogen in response to the increase in of hydrogen being transferred or transported to the generators 106.

In some embodiments, if the fuel storage 104A is empty and/or the hydrogen production facility 102 is unable to produce sufficient hydrogen to power the generators 106, hydrogen from the emergency storage 104B may be transferred or transported to the generators 106. As described above, the emergency storage 104B may be configured to store sufficient hydrogen to power the generators 106 for at least a minimum amount of time. In some embodiments, a backup hydrogen source 18 may be connected to the electrical system 100 and/or the storage system 104. The backup hydrogen source 18 may be configured to provide hydrogen to power the generators 106 if the hydrogen production facility 102 is unable to produce sufficient hydrogen and/or the emergency storage 104B is low or empty. For example, the second power source 112 may include solar panels and the solar panels may not be able generate power at night in order to power the hydrogen production facility 102. Therefore, the hydrogen production facility 102 may produce hydrogen during the day so the storage system 104 may provide hydrogen to the generators 106, and the backup hydrogen source 18 may provide hydrogen to the generators 106 at night. In some embodiments, the backup hydrogen source 18 may include a tank truck (e.g., fuel truck) or an additional hydrogen storage.

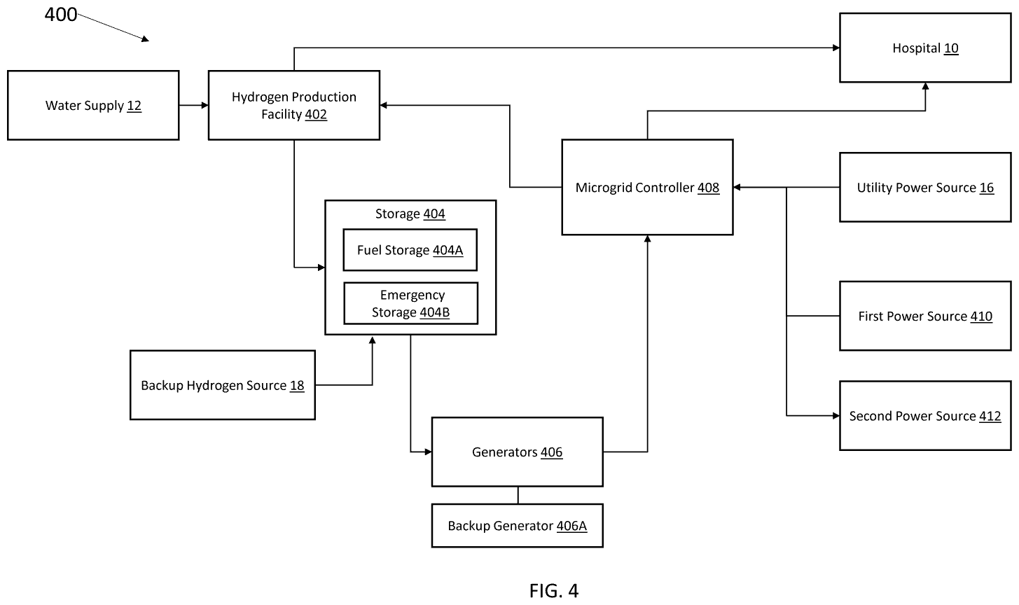

FIG. 4 illustrates an electrical system 400. The electrical system 100 can have any of the features of the electrical system 400 in FIG. 4, and the electrical system 400 in FIG. 4 can have any features of the electrical system 100 in FIGS. 1-3 except the differences described with reference to FIG. 4. As described above, the electrical system 100 may be connected to the natural gas supply 14. In FIG. 4, the electrical system 400 may not be connected to a natural gas supply, such as natural gas supply 14. Accordingly, the electrical system 400 may power the hospital 10 without relying on natural gas as fuel for generators 406.

In the electrical system 400, the microgrid controller 408 may transfer or transport power from utility power source 16, the first power source 410 and/or the second power source 412 to the hydrogen production facility 402 in order to power the hydrogen production facility 402. The hydrogen production facility 402 may be configured to generate hydrogen. The hydrogen generated by the hydrogen production facility 402 may be transported to the storage system 404. The storage system 404 may include the fuel storage 404A and/or the emergency storage 404B. The storage system 404 may provide hydrogen to the generators 406 and/or the backup generator 406A. In some embodiments, the backup hydrogen source 18 may be connected to the electrical system 400 and/or the storage system 404.

The generators 406 and/or the backup generator 406A may be configured to use only hydrogen as fuel. The generators 406 and/or the backup generator 406A may produce power. The microgrid controller 408 may be configured to transfer or transport the power produced by the microgrid controller 408 to the hospital 10. In some embodiments, the microgrid controller 408 may transfer or transport power from the utility power source 16 to the hospital 10.

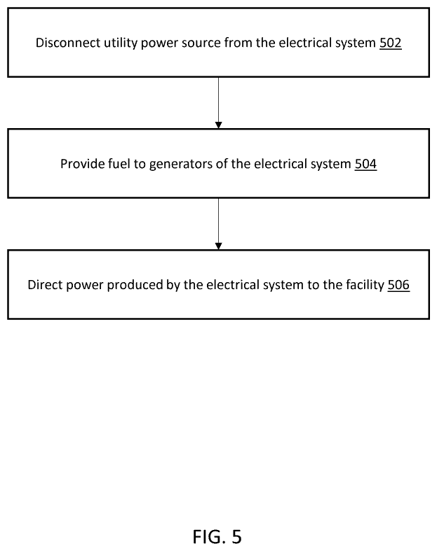

FIG. 5 illustrates a method 500 of powering a facility with an electrical system, such as electrical systems 100, 400 during an emergency event. The electrical system may power the facility during a nonemergency event, as described with reference to FIG. 1. One or more steps of method 500 may be performed to power the facility with the electrical system during an emergency event, as described with reference to FIGS. 1-4. It is to be appreciated that although method 500 is described with respect to steps 502-506, method 500 may include any of the features, actions, or steps of operating the electrical system 100, 400 during an emergency event described with reference to FIG. 1-4.

At step 502, a utility power source may be disconnected from the electrical system. The utility power source may be disconneced from the electrical system by a microgrid controller of the electrical system. In some embodiments, the utility power source may be disconnected in response to a power outage. In some embodiments, the power outage may cause the utility power source to be disconnected from the electrical system.

At step 504, fuel may be provided to generators of the electrical system. The fuel may include hydrogen and/or natural gas. The hydrogen may be provided to the generators from a storage system of the electrical system. A fuel storage of the storage system and/or an emergency storage of the storage system may provide hydrogen to the generators. The hydrogen may be provided to the storage system from a hydrogen production facility of the electrical system. The hydrogen may be provided to the generators and/or the storage system from backup hydrogen source connected to the electrical system. The natural gas may be provided to the generators from a natural gas supply connected to the electrical system. In some embodiments, fuel may already be provided to the generators during a non-emergency event and/or before the emergency event.

At step 506, power produced by the electrical system may be directed to the facility to power the facility. The power produced by the electrical system may be directed to the facility by the microgrid controller. The power produced by the electrical system may include power produced by the generators of the electrical system at step 504, a first power source of the electrical system, and/or a second power source of the electrical system. The power produced by the electrical system may include power produced by the generators of the electrical system during the emergency event, power produced by the generators during the non-emergency event and stored in a battery energy storage system, and/or power produced by a renewable energy source.

### Certain Terminology

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### SUMMARY

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. An electrical system for powering a facility, the electrical system comprising:
a hydrogen production facility connected to a water source, the hydrogen production facility located on-site at the facility, the hydrogen production facility configured to generate hydrogen;
a storage system located on-site at the facility, the storage system comprising a fuel storage and an emergency storage, the fuel storage and the emergency storage configured to hold hydrogen generated by the hydrogen production facility;
a plurality of generators, wherein each of the plurality of generators is configured to produce power using fuel, wherein the fuel comprises hydrogen from the fuel storage and natural gas from a natural gas source;
a renewable energy power source configured to produce power;
a battery energy storage system configured to store power produced by the renewable energy source and/or the plurality of generators; and
a microgrid controller connected to a utility power source and the plurality of generators,
wherein the microgrid controller is configured to direct power from the utility power source to the facility during a non-emergency event and to direct power produced by the plurality of generators instead of the power from the utility power source to the facility during an emergency event, and
wherein the microgrid controller is configured to direct power from one of the utility power source, the renewable energy power source, or the battery energy storage system to the hydrogen production facility.

2. The electrical system of claim 1, wherein the facility is a hospital.

3. The electrical system of claim 1, wherein each of the plurality of generators comprises a linear generator or a fuel cell.

4. The electrical system of claim 1, wherein the hydrogen production facility is configured to generate hydrogen via electrolysis.

5. The electrical system of claim 1, wherein the hydrogen production facility is configured to generate hydrogen, water, oxygen, and heat, and wherein the hydrogen production facility is configured to transport the water, the oxygen, and the heat to the facility.

6. The electrical system of claim 5, wherein the hydrogen production facility is configured to refine the oxygen.

7. The electrical system of claim 1, wherein the emergency storage is configured to provide hydrogen to the plurality of generators to power the plurality of generators during an emergency event.

8. The electrical system of claim 7, wherein the emergency storage is configured to store an amount of hydrogen to power the plurality of generators for 96 hours.

9. The electrical system of claim 1, wherein the renewable energy power source comprises a solar power source, a wind power source, and/or a hydropower source.

10. The electrical system of claim 2, further comprising a backup hydrogen source connected to the storage system.

11. An electrical system for powering a facility, the electrical system comprising:
a hydrogen production facility connected to a water source, the hydrogen production facility located on-site at the facility, the hydrogen production facility configured to generate hydrogen;
a storage system located on-site at the facility configured to hold hydrogen generated by the hydrogen production facility;
a generator configured to produce power using fuel, wherein the fuel comprises hydrogen from the storage system; and
a microgrid controller connected to a utility power source and the generator,
wherein the microgrid controller is configured to direct power from the utility power source to the facility during a non-emergency event and to direct power produced by the generator instead of the power from the utility power source to the facility during an emergency event.

12. The electrical system of claim 10, wherein the facility is a hospital.

13. The electrical system of claim 10, wherein the generator comprises a linear generator or a fuel cell.

14. The electrical system of claim 10, wherein the storage system comprises a fuel storage and an emergency storage.

15. The electrical system of claim 14, wherein the fuel comprises hydrogen from the fuel storage.

16. The electrical system of claim 14, wherein the emergency storage is configured to provide hydrogen to the generator to power the generator during an emergency event.

17. A method of powering a facility with an electrical system during an emergency event, wherein power is provided to the facility from a utility power source during a non-emergency event, the method comprising:
disconnecting, by a microgrid controller of the electrical system, the utility power source from the electrical system,
directing, by a microgrid controller, power produced by a plurality of generators of the electrical system to the facility to power the facility,
wherein the plurality of generators are configured to produce power using fuel, wherein the fuel comprises hydrogen produced by a hydrogen production facility located on-site at the facility.

18. The method of claim 17, wherein the electrical system comprises a storage system located on-site at the facility, the storage system comprising a fuel storage and an emergency storage, the fuel storage and the emergency storage configured to hold hydrogen generated by the hydrogen production facility, the method further comprising:
providing hydrogen from the storage system to the plurality of generators.

19. The method of claim 18, wherein the electrical system comprises a renewable energy source configured to produce power, and a battery energy storage system configured to store power produced by the renewable energy source and/or the plurality of generators.

20. The method of claim 17, wherein the facility is a hospital.
